(19) United States
(12) Patent Application Publication
(10) Pub. No.: US 2025/0092211 A1
(43) Pub. Date: Mar. 20, 2025

(54) PREPREG, FIBER-REINFORCED COMPOSITE MATERIAL, TUBULAR BODY MADE OF FIBER-REINFORCED COMPOSITE MATERIAL, GOLF CLUB SHAFT, AND FISHING ROD

(71) Applicant: TORAY INDUSTRIES, INC., Tokyo (JP)

(72) Inventors: Yasuyuki OMMURA, Iyo-gun (JP); Masanori HIRANO, Iyo-gun (JP); Kentaro SANO, Iyo-gun (JP)

(73) Assignee: TORAY INDUSTRIES, INC., Tokyo (JP)

(21) Appl. No.: 18/728,312

(22) PCT Filed: Jan. 10, 2023
(86) PCT No.: PCT/JP2023/000271

§ 371 Date: Jul. 11, 2024

(30) Foreign Application Priority Data
Feb. 16, 2022 (JP) 2022-021921

(51) Int. Cl. C08J 5/24; A01K 87/00; A63B 53/10; C08L 63/04

(52) U.S. Cl. CPC C08J 5/24; A63B 53/10; C08L 63/04; A01K 87/00; A63B 2209/02; C08J 2363/04; C08L 2205/025

(57) ABSTRACT

An object of the present invention is to provide a prepreg which has both excellent mechanical properties such as strength and elastic modulus and excellent appearance such as low-coloring property, transparency and weather resistance, and which also has an excellent tacking property, as well as to provide a fiber-reinforced composite material, a tubular fiber-reinforced composite material, a golf club shaft and a fishing rod, using the prepreg. The gist of the present invention is a prepreg including reinforcing fibers and a resin composition, wherein the resin composition contains the following component [A] to component [D]: component [A]: epoxy resins; component [B]: dicyandiamide; component [C]: a compound which has a boiling point of 130° C. or higher and a molecular weight m of 50 or more and 250 or less, which does not contain an epoxy group within the molecular structure, and which substantially does not have an epoxy resin curing ability; and component [D]: a phenoxy resin; and wherein the resin composition satisfies the following requirements (1) to (3): (1): the resin composition contains from 10 to 40 parts by mass of an isocyanurate type epoxy resin [A1], as the component [A], with respect to 100 parts by mass of the total epoxy resin: (2): the resin composition contains from 10 to 50 parts by mass of a novolac type epoxy resin [A2], as the component [A], with respect to 100 parts by mass of the total epoxy resin; and
(3): the resin composition contains 10 parts by mass or less of a glycidylamine type epoxy resin [A3], as the component [A], with respect to 100 parts by mass of the total epoxy resin.

### TECHNICAL FIELD

The present invention relates to a prepreg, a fiber-reinforced composite material and a tubular fiber-reinforced composite material, which are suitably used in fiber-reinforced composite materials for aerospace applications, general industrial applications, sports applications and the like. The present invention also relates to a golf club shaft and a fishing rod using the tubular fiber-reinforced composite material.

### BACKGROUND ART

Fiber-reinforced composite materials using carbon fibers, aramid fibers or the like as reinforcing fibers are widely used in structural materials for aircrafts, automobiles and the like, as well as sports and general industrial applications, such as tennis rackets, golf club shafts, fishing rods, bicycles, casings, and the like, utilizing their high specific strength and specific modulus. Thermosetting resins are mainly used in resin compositions for use in such fiber-reinforced composite materials, from the viewpoint of heat resistance and productivity. Above all, epoxy resins are preferably used from the viewpoint of mechanical properties, such as adhesion to reinforcing fibers.

There is a growing demand for improvements in various physical properties, in recent years, in order to use fiber-reinforced composite materials in applications such as golf club shafts, fishing rods and bicycles, for which further reduction in weight is demanded. For example, a prepreg to be used for a tubular body such as a golf club shaft or a fishing rod, is required to have an excellent tacking property, in order to prevent the peeling of the wound prepreg when shaped into a tubular form. Further, a fiber-reinforced composite material to be used for a tubular body is required to have a high strength in the fiber direction and in the non-fiber direction, in order to achieve an excellent flexural strength in the tubular body. Such a strength is greatly affected by the strength and the elastic modulus of an epoxy resin itself to be used as a matrix resin. In addition, there are increasing number of cases in which the surface of a fiber-reinforced composite material is coated with a clear coating, and the cross pattern or the like of the reinforcing fibers is used as a design. Therefore, there is a growing tendency to place a greater importance on the appearance, such as low-coloring property, transparency and weather resistance, of the cured product of the epoxy resin to be used as a matrix resin, in addition to the fact that the cured product shows excellent mechanical properties.

In order to solve the above-mentioned problems, Patent Literature 1 examines a technique of improving the resin strength by incorporating an additive, in order to reduce the situation in which dicyandiamide used as a curing agent remains without being completely dissolved to cause defects, from the viewpoint of improving mechanical properties. Further, Patent Literature 2 examines a technique of reducing the content of dicyandiamide, which causes the impairment of the appearance of the resulting molded article, and obtaining a cured product by the self-polymerization of an epoxy resin, from the viewpoint of improving the appearance.

### CITATION LIST

### Patent Literature

Patent Literature 1: WO 2019/181402
Patent Literature 2: WO 2018/003691

### SUMMARY OF INVENTION

### Technical Problem

The use of the technique disclosed in Patent Literature 1 enables to obtain the effect of improving the resin strength. However, no consideration is given to the appearance such as low-coloring property and weather resistance, and there are cases where excellent appearance cannot be obtained. Further, the use of the technique disclosed in Patent Literature 2 enables to obtain a resin cured product or a molded article having an excellent appearance. However, the resulting resin cured product may have a low flexural strength or elastic modulus, possibly resulting in insufficient mechanical properties. Further, a desired tackiness may not be obtained sufficiently by the technique disclosed in Patent Literature 2, and there is a room for improvement in handleability, as well.

Accordingly, an object of the present invention is to provide a prepreg which has both excellent mechanical properties such as strength and elastic modulus and excellent appearance such as low-coloring property, transparency and weather resistance, and which also has an excellent tacking property, as well as to provide a fiber-reinforced composite material, a tubular fiber-reinforced composite material, a golf club shaft and a fishing rod, using the prepreg.

### Solution to Problem

The present invention employs the following means in order to solve such problems. Specifically, the prepreg according to the present invention is a prepreg including reinforcing fibers and a resin composition,
wherein the resin composition contains the following component [A] to component [D]:
   component [A]: epoxy resins;
   component [B]: dicyandiamide;
   component [C]: a compound which has a boiling point of 130° C. or higher and a molecular weight m of 50 or more and 250 or less, which does not contain an epoxy group within the molecular structure, and which substantially does not have an epoxy resin curing ability; and
   component [D]: a phenoxy resin; and
wherein the resin composition satisfies the following requirements (1) to (3):
   (1): the resin composition contains from 10 to 40 parts by mass of an isocyanurate type epoxy resin [A1], as the component [A], with respect to 100 parts by mass of the total epoxy resin;
   (2): the resin composition contains from 10 to 50 parts by mass of a novolac type epoxy resin [A2], as the component [A], with respect to 100 parts by mass of the total epoxy resin; and
   (3): the resin composition contains 10 parts by mass or less of a glycidylamine type epoxy resin [A3], as the component [A], with respect to 100 parts by mass of the total epoxy resin.

The fiber-reinforced composite material according to the present invention is a fiber-reinforced composite material obtained by curing the prepreg described above.

The tubular fiber-reinforced composite material according to the present invention is a tubular fiber-reinforced composite material obtained by molding the prepreg described above, in the form of a tube.

The golf club shaft according to the present invention is a golf club shaft using the tubular fiber-reinforced composite material described above.

The fishing rod according to the present invention is a fishing rod using the tubular fiber-reinforced composite material.

### Advantageous Effects of Invention

According to the present invention, it is possible to obtain a prepreg which has both excellent mechanical properties and excellent appearance in a balanced manner, and which also has an excellent tacking property, as well as to obtain a fiber-reinforced composite material, a tubular fiber-reinforced composite material, a golf club shaft and a fishing rod, using the prepreg.

### DESCRIPTION OF EMBODIMENTS

The present invention will be described below in detail.

The prepreg according to the present invention contains a resin composition and reinforcing fibers. The prepreg is preferably composed of a resin composition and reinforcing fibers. An epoxy resin composition is used as the resin composition, and the resin composition contains component [A] to component [D] as essential components. In the present invention, the term “component” refers to a resin or a compound contained in the resin composition.

The component [A] in the present invention is epoxy resins contained in the resin composition. The component [A] is preferably epoxy resins having two or more epoxy groups within one molecule, because the cured product obtained by heat curing the resin composition has a high glass transition temperature and a high heat resistance. The resin composition may contain an epoxy resin having one epoxy group within one molecule, as long as the epoxy resin does not markedly adversely affect the heat resistance and mechanical properties of the epoxy resin composition or the resulting fiber-reinforced composite material.

Examples of such epoxy resins include epoxy resins such as bisphenol type epoxy resins, isocyanurate type epoxy resins, phenol novolac type epoxy resins, cresol novolac type epoxy resins, dicyclopentadiene type epoxy resins, diaminodiphenylmethane type epoxy resins, diaminodiphenylsulfone type epoxy resins, aminophenol type epoxy resins, m-xylenediamine type epoxy resins, 1,3-bisaminomethylcyclohexane type epoxy resins, hydantoin type epoxy resins, sorbitol type epoxy resins, trishydroxyphenylmethane type epoxy resins and tetraphenylolethane type epoxy resins.

In order to satisfy the requirement (1) in the present invention, it is necessary that the resin composition contain an isocyanurate type epoxy resin [A1](hereinafter, also simply referred to as “[A1]”) as the component [A]. When the resin composition contains [A1], the flexural elastic modulus of the resulting resin cured product is increased, and a reduced coloring and an improved weather resistance of the resin cured product are achieved, making it possible to obtain a fiber-reinforced composite material having excellent mechanical properties and appearance.

It is necessary that the resin composition contains from 10 to 40 parts by mass of [A1], with respect to 100 parts by mass of the total epoxy resin contained in the resin composition. The lower limit of the amount of [A1] is preferably 15 parts by mass or more, and the upper limit thereof is preferably 30 parts by mass or less. When the resin composition contains [A1] within the range described above, the coloring and the cloudiness of the resulting resin cured product can be reduced, and the balance between the elastic modulus and the appearance (color and degree of transparency) is good.

Examples of commercially available products of [A1] which can be used include: “TEPIC (registered trademark)” -G, -S, -L, -VL and -PAS B22 (all of the above manufactured by Nissan Chemical Industries, Ltd.); and “ARALDITE (registered trademark)” PT9810 (manufactured by Huntsman Advanced Materials, Inc.).

Further, in order to satisfy the requirement (2) in the present invention, it is necessary that the resin composition contain a novolac type epoxy resin [A2](hereinafter, also simply referred to as “[A2]”) as the component [A]. When the resin composition contains [A2], the coloring of the resulting resin cured product is reduced, and the tacking property of the prepreg is improved, making it possible to obtain a prepreg having an excellent tacking property and a fiber-reinforced composite material having an excellent appearance.

It is necessary that the resin composition contain from 10 to 50 parts by mass of [A2] with respect to 100 parts by mass of the total epoxy resin contained in the resin composition. The lower limit of the amount of [A2] is preferably 15 parts by mass or more, and the upper limit thereof is preferably 40 parts by mass or less. When the resin composition contains [A2] within the range described above, the coloring and the cloudiness of the resulting resin cured product can be reduced, and the balance between the tacking property and the appearance (color and degree of transparency) of the prepreg is good.

[A2] may be, for example, a phenol novolac type epoxy resin or a cresol novolac type epoxy resin. In particular, it is preferred to use a resin having a softening point of from 60 to 110° C., and more preferred to use a resin having a softening point of from 70 to 100° C., as the phenol novolac type epoxy resin or the cresol novolac type epoxy resin, because it allows for achieving well-balanced physical properties, such as the tacking property of the resulting prepreg.

Examples of commercially available products of the phenol novolac type epoxy resin include: “jER (registered trademark)” 152 and 154 (both manufactured by Mitsubishi Chemical Corporation); EPPN-201 (manufactured by Nippon Kayaku Co., Ltd.); and “EPICLON (registered trademark)” N-740, N-770 (softening point: from 65 to 75° C.), and N-775 (softening point: from 70 to 80° C., all of the above manufactured by DIC Corporation).

Examples of commercially available products of the cresol novolac type epoxy resin include “EPICLON (registered trademark)” N-660 (softening point: from 62 to 70° C.), N-665 (softening point: from 65 to 74° C.), N-670 (softening point: from 69 to 77° C.), N-673 (softening point: from 73 to 82° C.), N-680 (softening point: from 82 to 92° C.), N-690 (softening point: from 88 to 98° C.) and N-695 (softening point: from 90 to 100° C.: all of the above manufactured by DIC Corporation).

In order to satisfy the requirement (3) in the present invention, it is necessary that the resin composition contain 10 parts by mass or less, more preferably 5 parts by mass or less, of a glycidylamine type epoxy resin [A3] (hereinafter, also simply referred to as “[A3]”), as the component [A], with respect to 100 parts by mass of the total epoxy resin. It is still more preferred that the resin composition does not substantially contain [A3]. The glycidylamine type epoxy resin refers to an epoxy resin containing a glycidyl amino group. When the content of [A3] is adjusted to 10 parts by mass or less, a reduced coloring and an improved weather resistance of the resulting resin cured product are achieved, making it possible to obtain a fiber-reinforced composite material having an excellent appearance (color and weather resistance). The expression “the resin composition does not substantially contain [A3]” means that the content of [A3] is less than 1 parts by mass, including the case where the content is 0 part by mass, with respect to 100 parts by mass of the total epoxy resin.

[A3] may be, for example a diaminodiphenylmethane type epoxy resin, a diaminodiphenylsulfone type epoxy resin, an aminophenol type epoxy resin, a m-xylenediamine type epoxy resin or a 1,3-bisaminomethylcyclohexane type epoxy resin.

Examples of commercially available products of the diaminodiphenylmethane type epoxy resin include: ELM434 (manufactured by Sumitomo Chemical Co., Ltd.); “ARALDITE (registered trademark)” MY720, MY721, MY9512 and MY9663 (all of the above manufactured by Huntsman Advanced Materials, Inc.); Epotohto (registered trademark)” YH-434 (manufactured by NIPPON STEEL Chemical & Material Co., Ltd.); and jER (registered trademark)” 604 (manufactured by Mitsubishi Chemical Corporation).

Examples of commercially available products of the diaminodiphenylsulfone type epoxy resin include TG3DAS (manufactured by Mitsui Fine Chemicals, Inc.).

Examples of commercially available products of the aminophenol type epoxy resin include: ELM120 and ELM100 (both manufactured by Sumitomo Chemical Co., Ltd.); “JER (registered trademark)” 630 (manufactured by Mitsubishi Chemical Corporation); and “ARALDITE (registered trademark)” MY0500, MY0510, MY0600 and MY0610 (all of the above manufactured by Huntsman Advanced Materials, Inc.).

Examples of commercially available products of the m-xylenediamine type epoxy resin include “TETRAD (registered trademark)” -X (manufactured by Mitsubishi Gas Chemical Co., Ltd.).

Examples of commercially available products of the 1,3-bisaminomethylcyclohexane type epoxy resin include “TETRAD (registered trademark)” -C (manufactured by Mitsubishi Gas Chemical Co., Ltd.).

It is preferred that the resin composition contain a bisphenol type epoxy resin [A4](hereinafter, also simply referred to as “[A4]”) as the component [A]. When the resin composition contains [A4], the viscosity of the resin composition can be adjusted without impairing the color, the degree of transparency and the weather resistance of the resulting resin cured product, making it possible to improve the tackiness of the resulting prepreg. Therefore, it is preferred to contain [A4] in order to obtain a prepreg having an excellent handleability.

[A4] may be, for example, a bisphenol A type epoxy resin or a bisphenol F type epoxy resin. The resin composition preferably contains from 10 to 60 parts by mass of [A4], with respect to 100 parts by mass of the total epoxy resin contained in the resin composition. The lower limit of the amount of [A4] is more preferably 15 parts by mass or more, and the upper limit thereof is more preferably 50 parts by mass or less.

Examples of commercially available products of the bisphenol A type epoxy resin include: “jER (registered trademark)” 825, 828, 834, 1001, 1002, 1003, 1003F, 1004, 1004AF, 1005F, 1006FS, 1007 and 1009, 1010 (all of the above, manufactured by Mitsubishi Chemical Corporation); “EPICLON (registered trademark)” 850 (manufactured by DIC Corporation): “Epotohto (registered trademark)” YD-128 (manufactured by NIPPON STEEL Chemical & Material Co., Ltd.); and DER-331 and -332 (both manufactured by Dow Chemical Company).

Examples of commercially available products of the bisphenol F type epoxy resin include, “ARALDITE (registered trademark)” GY282 (manufactured by Huntsman Advanced Materials, Inc.): “jER (registered trademark)” 806, 807, 4005P, 4007P and 4010P (all of the above, manufactured by Mitsubishi Chemical Corporation): “EPICLON (registered trademark)” 830 (manufactured by DIC Corporation), and “Epotohto (registered trademark)” YD-170 (manufactured by NIPPON STEEL Chemical & Material Co., Ltd.).

The total amount of the isocyanurate type epoxy resin [A1], the novolac type epoxy resin [A2] and bisphenol type epoxy resin [A4], as the component [A], is preferably 96% by mass or more, more preferably 99% by mass or more, and still more preferably 100% by mass of the total epoxy resin, because excellent mechanical properties (strength and elastic modulus) and appearance (color, degree of transparency and weather resistance) of the resulting resin cured product, and an excellent tacking property of the prepreg can be obtained. Further, it is not possible to prevent the inclusion of an epoxy resin other than [A1] to [A4] described above, as the component [A], in the present invention. The amount of such an epoxy resin is preferably less than 4% by mass, when the total amount of the epoxy resins is taken as 100% by mass.

The component [B] in the present invention is dicyandiamide contained in the resin composition. Dicyandiamide is excellent in that it gives high mechanical properties and heat resistance to the cured product of the epoxy resins, and is widely used as a curing agent for various types of epoxy resins. Further, dicyandiamide can be suitably used, because it is excellent in the preservation stability of the epoxy resin composition. Examples of the commercially available products of dicyandiamide as described above include DICY7 and DICY15 (both manufactured by Mitsubishi Chemical Corporation).

In the present invention, the content of the component [B] is preferably from 4 to 9 parts by mass, and more preferably from 5 to 7 parts by mass, with respect to 100 parts by mass of the total epoxy resin, because excellent balance between the mechanical properties and the transparency of the resulting resin cured product can be achieved.

The component [C] in the present invention is a compound contained in the resin composition, which compound has a boiling point of 130° C. or higher and a molecular weight m of 50 or more and 250 or less, which does not contain an epoxy group within the molecular structure, and which substantially does not have an epoxy resin curing ability. In the present invention, compounds such as amines and phenols capable of undergoing addition reactions with epoxy resins, acid anhydrides capable of being copolymerized with epoxy resins, imidazoles capable of serving as self-polymerization reaction initiators of epoxy resins, aromatic urea compounds and tertiary amine compounds, are compounds having an epoxy resin curing ability. The expression “substantially does not have an epoxy resin curing ability” means that such a compound does not chemically react with epoxy resins, and is not involved in the self-polymerization of epoxy resins, as well.

The component [C] is present in the void portion of a cross-linked structure formed by the reaction of the epoxy resins and dicyandiamide, without being taken up into the cross-linked structure. That is, it is thought that the component [C] is included in the cross-linked structure, and maintains the same state as before the curing of the epoxy resins without being involved in any chemical change and physical change even after the curing of the epoxy resins. As a result, it is thought that the elastic modulus of the resulting epoxy resin cured product is increased. Surprisingly, the incorporation of the component [C] allows for obtaining an epoxy resin cured product which not only has a high elastic modulus, but also has a high elongation and a high strength.

When the component [C] has a boiling point of 130° C. or higher, more preferably 180° C. or higher, the volatilization of the component [C] during the curing of the epoxy resin composition can be reduced, making it possible to obtain a resin cured product or a fiber-reinforced composite material having excellent mechanical properties. It is preferred that the boiling point of the component [C] be adjusted within such a range, because the generation of voids or a decrease in the mechanical properties in the resulting fiber-reinforced composite material can be reduced. The upper limit of the boiling point of the component [C] is not particularly limited, but it is suitable to use a compound having a boiling point of 400° C. or lower, as the compound to be usually used in the present invention.

The resin composition preferably contains from 1 to 15 parts by mass, more preferably from 2 to 10 parts by mass, and still more preferably from 3 to 6 parts by mass of the component [C], with respect to 100 parts by mass of the component [A].

The component [C] has a molecular weight m of 50 or more and 250 or less, and more preferably 70 or more and 120 or less. When the molecular weight of the component [C] is adjusted within such a range, the component [C] is adequately retained in the void portion of the cross-linked structure formed by the reaction of the epoxy resins and dicyandiamide, making it possible to obtain a cured product having an excellent elastic modulus, strength and elongation.

In the present invention, the component [C] is preferably a compound having at least one functional group selected from the group consisting of an amide group, a ketone group and a hydroxyl group, within the molecular structure. When the component [C] (has a high-polarity functional group such as one described above within the molecular structure, a strong intermolecular interaction acts between the hydroxyl group in the cross-linked structure formed from the component [A] and the component [B], and the component [C]. This facilitates the component [C] to be more adequately retained in the void portion of the cross-linked structure, making it possible to obtain a particularly excellent effect of improving the elongation and strength.

Examples of the component [C] as described above include: amides such as N-methylformamide, N-methylacetamide, 2-pyrrolidone, N-methylpropionamide, N-ethylacetamide, N-methylacetanilide and N,N′-diphenylacetamide; and diols such as ethanediol, propanediol, butanediol, pentanediol, hexandiol and heptanediol. These compounds may be used singly, or may be used in an appropriate mixture.

The component [D] in the present invention is a phenoxy resin contained in the resin composition. The phenoxy resin is capable of improving the viscosity of the resin composition or the tackiness of the resulting prepreg, without impairing the color, the degree of transparency and the weather resistance of the resulting resin cured product. Therefore, when the resin composition contains the component [D], a prepreg having an excellent tacking property and a fiber-reinforced composite material having an excellent appearance can be obtained. The resin composition preferably contains from 3 to 20 parts by mass, and more preferably from 5 to 15 parts by mass of the component [D], with respect to 100 parts by mass of the component [A].

The resin composition to be used for the prepreg according to the present invention may contain a curing accelerator, from the viewpoint of controlling the curing rate. The curing accelerator may be, for example, a urea compound, an imidazole compound, or the like. In particular, a urea compound is preferably used from the viewpoint of the shelf stability of the epoxy resin composition.

Examples of the urea compound include 3-(3,4-dichlorophenyl)-1,1-dimethylurea, 3-(4-chlorophenyl)-1,1-dimethylurea, phenyldimethylurea and toluene bisdimethylurea. Further, DCMU99 (manufactured by Hodogaya Chemical Co., Ltd.), “Omicure (registered trademark)” 24 (manufactured by PTI Japan, Ltd.) or the like can be used as a commercially available product of an aromatic urea compound.

Preferred examples of the reinforcing fibers to be used in the prepreg and the fiber-reinforced composite material according to the present invention include carbon fibers, graphite fibers, aramid fibers and glass fibers. It is particularly preferred to use carbon fibers. The form and the arrangement of the reinforcing fibers are not limited. For example, a fiber structure such as unidirectionally aligned continuous fibers, a single tow, a woven fabric, a knitted fabric, a braid or the like is used. As the reinforcing fibers, it is also possible to use a combination of two or more types of: carbon fibers, glass fibers, aramid fibers, boron fibers, polybenzoxazole fibers, high-strength polyethylene fibers, alumina fibers, silicon carbide fibers and the like.

Specific examples of the carbon fibers include acrylic carbon fibers, pitch-based carbon fibers and rayon-based carbon fibers. In particular, acrylic carbon fibers having a high tensile strength are preferably used.

The carbon fibers can be used in the form of twisted yarns, untwisted yarns, non-twisted yarns or the like. However, the use of twisted yarns causes a decrease in the mechanical properties of the resulting carbon fiber-reinforced composite material, since the orientation of the filaments constituting the carbon fibers is not parallel, in twisted yarns. Accordingly, untwisted yarns or non-twisted yarns which allow for achieving a good balance between the moldability and strength properties of the carbon fiber-reinforced composite materials, are preferably used.

The carbon fibers preferably have a tensile elastic modulus within the range of from 200 to 440 GPa. The tensile elastic modulus of the carbon fibers is affected by the degree of crystallization of the graphite structure of the carbon fibers, and the higher the degree of crystallization is, the more improved the elastic modulus is. The carbon fibers preferably have a tensile elastic modulus within the range described above, because all of the rigidity and strength properties of the resulting carbon fiber-reinforced composite material are balanced at a high level. The carbon fibers more preferably have a tensile elastic modulus within the range of from 230 to 400 GPa, and still more preferably within the range of from 260 to 370 GPa. The tensile elastic modulus of the carbon fibers as used herein is a value measured in accordance with JIS R7601 (2006).

The prepreg according to the present invention can be produced by any of various known methods. For example, the prepreg can be produced by the hot melt method in which the viscosity of the resin composition is reduced by heating, without using an organic solvent, and then the reinforcing fibers are impregnated with the resin composition.

The hot melt method can be carried out, for example, by a process in which the reinforcing fibers are directly impregnated with the resin composition whose viscosity is reduced by heating, or by a process in which the resin composition is coated on a release paper or the like to prepare a release paper sheet with a resin film, first, and then the resin film is layered on one side or each of both sides of the reinforcing fibers, followed by heating and pressurization, thereby impregnating the reinforcing fibers with the resin composition.

The content of the reinforcing fibers in the prepreg is preferably from 30 to 90% by mass, more preferably from 35 to 85% by mass, and still more preferably from 65 to 85% by mass, when the mass of the prepreg is taken as 100% by mass. A low content of the reinforcing fibers leads to too high an amount of the resin, making the advantage of the fiber-reinforced composite material to have an excellent specific strength and specific modulus less likely to be obtained. In addition, there are cases where the amount of heat generated during curing may be excessively high, at the time of molding the fiber-reinforced composite material. On the other hand, too high a content of the reinforcing fibers may lead to a defective impregnation of the resin, and the resulting composite material may have a number of voids. Further, there is a risk that the tacking property of the prepreg may be impaired.

The fiber-reinforced composite material or the tubular fiber-reinforced composite material according to the present invention can be produced, for example, by a method in which the above-described prepregs according to the present invention are laminated in a predetermined form, followed by pressurization and heating to cure the resin. At this time, the application of heat and pressure can be carried out using a method such as press molding, autoclave molding, bagging molding, wrapping tape molding, internal pressure molding or the like.

The wrapping tape molding is particularly preferably used as the method of molding the tubular fiber-reinforced composite material. The wrapping tape molding is a method in which a prepreg is wound around a core such as a mandrel, to obtain a cylindrical molded product. Specifically, the wrapping tape molding is a method in which a prepreg is wound around a mandrel, a wrapping tape composed of a thermoplastic resin film is wrapped around the outer periphery of the wound prepreg in order to fix the prepreg and to apply a pressure thereto, and the resin is heat-cured in an oven, followed by pulling out the core, to obtain a cylindrical molded product. The wrapping tape molding is suitable when producing a rod-shaped member such as a golf club shaft or a fishing rod.

Since the tubular fiber-reinforced composite material according to the present invention is obtained by molding the above-described prepreg having an excellent tacking property, the peeling of the wound prepreg when shaped into a tubular form is reduced, and it is possible to obtain a tubular fiber-reinforced composite material with less defects such as voids. Further, when the prepreg according to the present invention is used, the cured product thereof has excellent mechanical properties, and therefore, the tubular fiber-reinforced composite material according to the present invention exhibits an excellent flexural strength.

The fiber-reinforced composite material or the tubular fiber-reinforced composite material according to the present invention can be widely used in aerospace applications, general industrial applications and sports applications. More specifically, the fiber-reinforced composite material or the tubular fiber-reinforced composite material is suitably used in structures such as automobiles, marine vessels and railroad vehicles, in general industrial applications. In sports application, the fiber-reinforced composite material or the tubular fiber-reinforced composite material is suitably used in the applications of golf club shafts, fishing rods, tennis rackets and badminton rackets. In particular, the tubular fiber-reinforced composite material according to the present invention can be suitably used for a golf club shaft or a fishing rod.

The upper limits and lower limits of the numerical ranges described above can be arbitrarily combined, unless otherwise specified.

### EXAMPLES

The present invention will now be described in further detail with reference to Examples. However, the present invention is in no way limited to these Examples. The unit “part(s)” used to describe a composition ratio refers to “part(s) by mass” unless otherwise specified. Further, the measurements of various properties (physical properties) were carried out in an environment of a temperature of 23° C. and a relative humidity of 50%, unless otherwise specified.

### Materials Used in Examples and Comparative Examples

### (1) Component [A]: Epoxy Resins

### Isocyanurate Type Epoxy Resin [A1]

[A1]-1 “TEPIC (registered trademark)” -S (epoxy equivalent: 100, manufactured by Nissan Chemical Industries, Ltd.) Novolac type epoxy resin [A2]
[A2]-1 EPICLON (registered trademark)” N-775 (phenol novolac type epoxy resin, epoxy equivalent: 189, manufactured by DIC Corporation)
[A2]-2 “EPICLON (registered trademark)” N-695 (cresol novolac type epoxy resin, epoxy equivalent: 214, manufactured by DIC Corporation)

### Glycidylamine Type Epoxy Resin [A3]

[A3]-1 “ARALDITE (registered trademark)” MY0600 (aminophenol type epoxy resin, epoxy equivalent: 118, manufactured by Huntsman Advanced Materials, Inc.)
[A3]-2 “SUMI-EPOXY (registered trademark)” ELM434 (diaminodiphenylmethane type epoxy resin, epoxy equivalent: 120, manufactured by Sumitomo Chemical Co., Ltd.)

### Bisphenol Type Epoxy Resin [A4]

[A4]-1 “EPICLON (registered trademark)” 830 (bisphenol F type epoxy resin, epoxy equivalent: 172, manufactured by DIC Corporation)
[A4]-2 “jER (registered trademark)” 4005P (bisphenol F type epoxy resin, epoxy equivalent: 1075, manufactured by Mitsubishi Chemical Corporation)

### (2) Component [B]: Dicyandiamide

[B]-1 DICY7 (dicyandiamide, manufactured by Mitsubishi Chemical Corporation)
   (3) Component [C]: Compound which has a boiling point of 130° C. or higher and a molecular weight m of 50 or more and 250 or less, which does not contain an epoxy group within the molecular structure, and which substantially does not have an epoxy resin curing ability
[C]-1 1,2-Propanediol (boiling point: 188° C., molecular weight m: 76, manufactured by Tokyo Chemical Industry Co., Ltd.)
[C]-2 2-Pyrrolidone (boiling point: 245° C., molecular weight m: 85, manufactured by Tokyo Chemical Industry Co., Ltd.)

### (4) Component [D]: Phenoxy Resin

[D]-1 “Phenotohto (registered trademark)” YP-70 (manufactured by NIPPON STEEL Chemical & Material Co., Ltd.)

### (5) Other Thermoplastic Resin (Hereinafter, Referred to as “Component [E]”)

[E]-1 “Vinylec (registered trademark)” K (polyvinyl formal, manufactured by JNC Corporation)
[E]-2 “SUMIKAEXCEL (registered trademark)” PES 5003P (polyethersulfone, manufactured by Sumitomo Chemical Co., Ltd.)
   (6) Curing Accelerator (Hereinafter. Referred to as “Component [F]”)
[F]-1 DCMU99 (3-(3,4-dichlorophenyl)-1,1-dimethylurea, manufactured by Hodogaya Chemical Co., Ltd.)

### (7) Carbon Fibers

“TORAYCA (registered trademark)” T1100 G-24K (number of fibers: 24,000, tensile elastic modulus: 324 GPa, manufactured by Toray Industries, Inc.)

### <Method of Preparing Epoxy Resin Composition>

### (1) Preparation of Curing Agent Master Batch

In each of the Examples and Comparative Examples, [A4]-1 was prepared in an amount corresponding to 10 parts by mass with respect to 100 parts by mass of the total amount of the epoxy resins. To the thus prepared [A4]-1, dicyandiamide as the component [B] was added in the amount shown in the table, and the resulting mixture was mixed at room temperature. The mixture was passed through a three-roll mill twice, to prepare a curing agent master batch.

### (2) Preparation of Epoxy Resin Composition

Of the components and amounts shown in the table, the total amount of the epoxy resins excluding [A4]-1 used in the section (1) described above, that is, the epoxy resins corresponding to 90 parts by mass when the total amount of the epoxy resins is taken as 100 parts by mass, was introduced into a beaker. After heating the mixture to 150° C. while kneading, the component as the component [D] or the component [E] in the amount shown in the table was introduced into the beaker, and the mixture was subjected to heat kneading at a temperature of 150° C. for one hour to dissolve the component. Subsequently, the resultant was cooled to a temperature of from 55 to 65° C. while continuing kneading, and then the curing agent master batch prepared in the section (1) as well as the components as the component [C] and the component [F] in the amounts shown in the table were introduced into the beaker. The resulting mixture was kneaded at the same temperature for 30 minutes, to obtain an epoxy resin composition.

### <Method of Preparing Epoxy Resin Cured Product>

The epoxy resin composition prepared in accordance with the section of <Method of Preparing Epoxy Resin Composition> described above was degassed in vacuum. Thereafter, the resin composition was heated from 30° C. at a rate of 1.7° C./min, in a mold which had been set so as to achieve a thickness of 2 mm with a 2 mm-thick “TEFLON (registered trademark)” spacer, and the temperature was retained for one hour after having reached 90° C. Subsequently, the resin composition was heated at a rate of 2.0° C./min, and cured for 2 hours after having reached a temperature of 135° C., to obtain a resin cured product in the form of a plate having a thickness of 2 mm.

For the evaluation of appearance, the curing reaction as described above was carried out in a mold which had been set so as to achieve a thickness of 1 mm with a 1 mm-thick “TEFLON (registered trademark)” spacer, to obtain a resin cured product in the form of a plate having a thickness of 1 mm.

### <Method of Preparing Prepreg>

The epoxy resin composition prepared in accordance with the section of <Method of Preparing Epoxy Resin Composition> described above was coated on a release paper using a knife coater, to prepare two pieces of resin films having a resin basis weight of 31 g/m². Subsequently, carbon fibers were unidirectionally aligned so as to be in the form of a sheet having a fiber basis weight of 125 g/m², and the above-prepared resin films were respectively layered on both surfaces of the carbon fibers, followed by heating and pressurization under the conditions of a temperature of 110° C. and a maximum pressure of 2 MPa to impregnate the carbon fibers with the epoxy resin composition, thereby obtaining a prepreg.

### <Various Evaluation Methods>

### (1) Three-point Bending Measurement of Epoxy Resin Cured Product

Test pieces each having a width of 10 mm and a length of 60 mm were cut out from the resin cured product having a thickness of 2 mm, which had been prepared in accordance with the section of <Method of Preparing Epoxy Resin Cured Product> describe above. Using an Instron universal tester (manufactured by Instron Corporation), the three-point bending measurement of the test pieces was carried out with a span of 32 mm, a cross-head speed of 2.5 mm/min and a number of samples of n=6, in accordance with JS K7171 (1994). The arithmetic mean values of the strength and the elastic modulus obtained by the measurement were defined as the flexural strength and the flexural elastic modulus of the resin cured product, respectively.

### (2) Evaluation of Degree of Yellowness of Epoxy Resin Cured Product

A test piece having a width of 37 mm and a length of 68 mm was cut out from the resin cured product having a thickness of 1 mm, which had been prepared in accordance with the section of <Method of Preparing Epoxy Resin Cured Product> describe above. Using a multi-light source spectrophotometer MSC-P (manufactured by Suga Test Instruments Co., Ltd.), the tristimulus values of the thus prepared test piece were determined by the reflection method with a D65 light source and a visual field of 10°, under the optical condition of d/8 excluding the specular reflection light. Based on the thus obtained tristimulus values, the degree of yellowness was calculated in accordance with JIS K7373 (2006).

### (3) Evaluation of Degree of Transparency of Epoxy Resin Cured Product

The resin cured product having a thickness of 1 mm, which had been prepared in accordance with the section of <Method of Preparing Epoxy Resin Cured Product> describe above was placed on a paper on which letters had been written, and the degree of transparency of the resin cured product was examined. The degree of transparency was evaluated as A when the letters were readable as clearly as before placing the resin cured product on the paper; evaluated as B when the letters were vague but readable; and evaluated as C when the letters were not readable.

### (4) Weather Resistance Test of Epoxy Resin Cured Product

A test piece having a width of 37 mm and a length of 68 mm was cut out from the resin cured product having a thickness of 1 mm, which had been prepared in accordance with the section of <Method of Preparing Epoxy Resin Cured Product> describe above. Using an accelerated weather resistance tester (Super Xenon Weather Meter SX-75, manufactured by Suga Test Instruments Co., Ltd.), the thus prepared test piece was subjected to a weather resistance test. In the weather resistance test, an irradiation without water injection for 102 minutes which is performed under the conditions of a strength of 180 W/m², a black panel temperature of 63° C. and a humidity of 50% RH, and an irradiation with water injection for 18 minutes which is performed under the conditions of a strength of 180 W/m², an in-tank temperature of 28° C. and a humidity of 99% RH, were taken as one cycle, and this cycle was repeated 12 times (that is, for 24 hours).

The weather resistance was evaluated by measuring the color difference (ΔE) of the cured product before and after the weather resistance test, using a multi-light source spectrophotometer MSC-P (manufactured by Suga Test Instruments Co., Ltd.). The tristimulus values (L*, a* and b*) were determined under the same conditions as in the above-described section of (2) Evaluation of Degree of Yellowness of Epoxy Resin Cured Product, and the color difference (ΔE) was calculated using the differences (ΔL*, Δa* and Δb*) in the tristimulus values before and after the weather resistance test, in accordance with the following equation (I).

$${{{{Δ E = \{ ( Δ L \text{*)}}^{2} + ( Δ a \text{*)}}^{2} + ( Δ b \text{*)}}^{2} \}}^{1 / 2} \qquad ( I )$$

### (5) Measurement of Tacking Property of Prepreg

The tacking property of the prepreg was measured using a tack tester (PICMA tack tester II, manufactured by Toyo Seiki Co., Ltd.). A 18 mm×18 mm-square cover glass was pressed and adhered to the prepreg with a force of 0.4 kgf (3.9 N) for 5 seconds, the cover glass was pulled vertically at a rate of 30 mm/min, and the resistance force when the cover glass peeled off from the prepreg was defined as the tack value.

### Example 1

An epoxy resin composition was prepared in accordance with the section of <Method of Preparing Epoxy Resin Composition> described above, using the following components: 25 parts by mass of “TEPIC (registered trademark)” -S as the component [A1], 35 parts by mass of “EPICLON (registered trademark)” N-775 as the component [A2], and 25 parts by mass of “EPICLON (registered trademark)” 830 and 15 parts by mass of “jER (registered trademark)” 4005P as the component [A4], among the epoxy resins as the component [A]; 5.4 parts by mass of DICY7 as dicyandiamide as the component [B]: 5 parts by mass of 1,2-propanediol as the component [C], 12 parts by mass of “Phenotohto (registered trademark)” YP-70 as the phenoxy resin as the component [D]; and 3 parts by mass of DCMU99 as the curing accelerator.

An epoxy resin cured product was prepared from the resulting resin composition, in accordance with the section of <Method of Preparing Epoxy Resin Cured Product>. The flexural strength, the flexural elastic modulus, the degree of yellowness, the degree of transparency and the weather resistance (color difference ΔE), of the thus prepared epoxy resin cured product, were measured. As a result, the epoxy resin cured product had a flexural strength of 193 Mpa, a flexural elastic modulus of 4.7 GPa, a degree of yellowness of 12, a degree of transparency of A and a color difference ΔE of 6.8, indicating that the resin cured product has good physical properties and appearance.

Further, a prepreg was prepared from the thus obtained resin composition in accordance with the section of <Method of Preparing Prepreg> described above, and the tacking property of the prepreg was measured. As a result, the prepreg had a tackiness of 1.7 kgf, showing an excellent tacking property.

### Examples 2 to 12

In each of the Examples, an epoxy resin cured product and a prepreg were prepared in the same manner as in Example 1, except that the composition of the resin composition was changed as shown in Table 1. The flexural strength, the flexural elastic modulus, the degree of yellowness, the degree of transparency and the weather resistance (color difference ΔE) of the epoxy resin cured product, as well as the tackiness of the prepreg, in each Example, were as shown in Table 1, which were all good.

### Comparative Example 1

An epoxy resin cured product and a prepreg were prepared in the same manner as in Example 1, except that the composition of the resin composition was changed as shown in Table 1. The evaluation results of physical properties are also shown in Table 1 (the same applies to the Comparative Examples to be described hereinafter). The epoxy resin cured product had a good degree of yellowness, degree of transparency and weather resistance, and the prepreg had a good tackiness. However, the flexural strength and the flexural elastic modulus of the epoxy resin cured product were lower than those in Example 7, because the content of [A1] in 100 parts by mass of the total epoxy resin was less than 10 parts by mass, failing to satisfy the requirement (1).

### Comparative Example 2

An epoxy resin cured product and a prepreg were prepared in the same manner as in Example 1, except that the composition of the resin composition was changed as shown in Table 1. The epoxy resin cured product had a good flexural elastic modulus, degree of yellowness and weather resistance, and the prepreg had a good tackiness. However, the flexural strength and the degree of transparency of the epoxy resin cured product were inferior to those in Example 6, because the content of [A1] in 100 parts by mass of the total epoxy resin was more than 40 parts by mass, failing to satisfy the requirement (1).

### Comparative Example 3

An epoxy resin cured product and a prepreg were prepared in the same manner as in Example 1, except that the composition of the resin composition was changed as shown in Table 1. The epoxy resin cured product had a good flexural elastic modulus, degree of yellowness, degree of transparency and weather resistance. However, the flexural strength of the epoxy resin cured product and the tackiness of the prepreg were lower than those in Example 7, because the content of [A2] in 100 parts by mass of the total epoxy resin was less than 10 parts by mass, failing to satisfy the requirement (2).

### Comparative Example 4

An epoxy resin cured product and a prepreg were prepared in the same manner as in Example 1, except that the composition of the resin composition was changed as shown in Table 1. The epoxy resin cured product had a good flexural elastic modulus, degree of yellowness and weather resistance, and the prepreg had a good tackiness. However, the flexural strength and the degree of transparency of the epoxy resin cured product were inferior to those in Example 4, because the content of [A2] in 100 parts by mass of the total epoxy resin was more than 50 parts by mass, failing to satisfy the requirement (2).

### Comparative Example 5

An epoxy resin cured product and a prepreg were prepared in the same manner as in Example 1, except that the composition of the resin composition was changed as shown in Table 1. The epoxy resin cured product had a good degree of yellowness, degree of transparency and weather resistance, and the prepreg had a good tackiness. However, the flexural strength and the flexural elastic modulus of the epoxy resin cured product were lower than those in Example 5 and Example 9, because the component [B] was not incorporated.

### Comparative Example 6

An epoxy resin cured product and a prepreg were prepared in the same manner as in Example 1, except that the composition of the resin composition was changed as shown in Table 1. The epoxy resin cured product had a good degree of yellowness, degree of transparency and weather resistance, and the prepreg had a good tackiness. However, the flexural strength and the flexural elastic modulus of the epoxy resin cured product were lower than those in Example 5, because the component [C] was not incorporated.

### Comparative Example 7

An epoxy resin cured product and a prepreg were prepared in the same manner as in Example 1, except that the composition of the resin composition was changed as shown in Table 1. The epoxy resin cured product had a good flexural strength and flexural elastic modulus, and the prepreg had a good tackiness. However, the degree of yellowness, the degree of transparency and the weather resistance of the resin cured product were inferior to those in Example 1, because the component [D] was not incorporated, and “Vinylec (registered trademark)” K was used as a thermoplastic resin as a substitute.

### Comparative Example 8

An epoxy resin cured product and a prepreg were prepared in the same manner as in Example 1, except that the composition of the resin composition was changed as shown in Table 1. The epoxy resin cured product had a good flexural strength, flexural elastic modulus and degree of transparency, and the prepreg had a good tackiness. However, the degree of yellowness and the weather resistance of the resin cured product were inferior to those in Example 1 and Example 8, because the content of [A3] in 100 parts by mass of the total epoxy resin was more than 10 parts by mass, failing to satisfy the requirement (3).

### Comparative Example 9

An epoxy resin cured product and a prepreg were prepared in the same manner as in Example 1, except that the composition of the resin composition was changed as shown in Table 1. The epoxy resin cured product had a good flexural strength, flexural elastic modulus and degree of transparency, and the prepreg had a good tackiness. However, the degree of yellowness and the weather resistance of the resin cured product were inferior to those in Example 1 and Example 8, because the content of [A3] in 100 parts by mass of the total epoxy resin was more than 10 parts by mass, failing to satisfy the requirement (3).

### Comparative Example 10

An epoxy resin cured product and a prepreg were prepared in the same manner as in Example 1, except that the composition of the resin composition was changed as shown in Table 1. The epoxy resin cured product had a good flexural strength, flexural elastic modulus, degree of yellowness and degree of transparency, and the prepreg had a good tackiness. However, the weather resistance of the resin cured product was inferior to that in Example 1, because the component [D] was not incorporated, and “SUMIKAEXCEL (registered trademark)” PES 5003P was used as a thermoplastic resin as a substitute.

TABLE 1

| | | | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|
| | | | am- | am- | am- | am- | am- | am- | am- | am- | am- | am- | am- | am- |
| | | | ple | ple | ple | ple | ple | ple | ple | ple | ple | ple | ple | ple |
| | | | l | 2 | 3 | 4 | 5 | 6 | 7 | 8 | 9 | 10 | 11 | 12 |
| Component | [A1] | “TEPIC”-S | 25 | 25 | 25 | 25 | 15 | 35 | 35 | 20 | 15 | 15 | 25 | 35 |
| [A] | [A2] | “EPICLON”N-775 | 35 | | 35 | 45 | 45 | 25 | 15 | 35 | 45 | 45 | | |
| | | “EPICLON”N-695 | | 35 | | | | | | | | | 15 | 45 |
| | [A3] | “ARALDITE” | | | | | | | | 5 | | | | 5 |
| | | MY0600 | | | | | | | | | | | | |
| | | “SUMI-EPOXY” | | | | | | | | | | | | |
| | | ELM434 | | | | | | | | | | | | |
| | [A4] | “EPICLON”830 | 25 | 25 | 25 | 25 | 25 | 25 | 35 | 25 | 25 | 25 | 35 | 15 |
| | | “jER”4005P | 15 | 15 | 15 | 5 | 15 | 15 | 15 | 15 | 15 | 15 | 25 | |

| | | | | | | | | | | | | | |
|---|---|---|---|---|---|---|---|---|---|---|---|---|---|
| Component [B] | DICY7 | 5.4 | 5.2 | 5.4 | 5.7 | 4.9 | 5.8 | 5.8 | 5.3 | 3.3 | 9.2 | 4.9 | 6.3 |
| Component [C] | 1,2-Propanediol | 5 | 5 | | 5 | 5 | 5 | 5 | 5 | 5 | 5 | | |
| | 2-Pyrrolidone | | | 5 | | | | | | | | 5 | 5 |
| Component [D] | “Phenotohto” | 12 | 12 | 12 | 12 | 12 | 12 | 12 | 12 | 12 | 12 | 12 | 12 |
| | YP-70 | | | | | | | | | | | | |
| Component [E] | “Vinylec”K | | | | | | | | | | | | |
| | “SUMIKAEXCEL” | | | | | | | | | | | | |
| | PES 5003P | | | | | | | | | | | | |
| Component [F] | DCMU99 | 3 | 3 | 3 | 3 | 3 | 3 | 3 | 3 | 3 | 3 | 3 | 3 |
| Properties | Flexural strength | 193 | 195 | 194 | 186 | 191 | 184 | 182 | 190 | 184 | 186 | 184 | 206 |
| of resin | [MPa] | | | | | | | | | | | | |
| cured product | Flexural elastic | 4.7 | 4.7 | 4.6 | 4.7 | 4.5 | 4.8 | 4.7 | 4.5 | 4.3 | 4.8 | 4.6 | 5.0 |
| | modulus [GPa] | | | | | | | | | | | | |
| | Degree of | 12 | 14 | 12 | 16 | 13 | 15 | 15 | 20 | 12 | 15 | 13 | 24 |
| | yellowness | | | | | | | | | | | | |
| | Degree of | A | A | A | B | A | B | B | A | A | B | A | B |
| | transparency | | | | | | | | | | | | |
| | Weather | 6.8 | 7.2 | 7.0 | 7.3 | 7.7 | 6.5 | 6.2 | 9.1 | 7.5 | 7.9 | 6.4 | 9.5 |
| | resistance (ΔE) | | | | | | | | | | | | |
| Properties of | Tackiness of | 1.7 | 1.8 | 1.7 | 1.6 | 1.8 | 1.5 | 1.4 | 1.4 | 1.7 | 1.8 | 1.5 | 1.6 |
| prepreg | prepreg [kgf] | | | | | | | | | | | | |

| | | | Com- | Com- | Com- | Com- | Com- | Com- | Com- | Com- | Com- | Com- |
|---|---|---|---|---|---|---|---|---|---|---|---|---|
| | | | par- | par- | par- | par- | par- | par- | par- | par- | par- | par- |
| | | | ative | ative | ative | ative | ative | ative | ative | ative | ative | ative |
| | | | Ex- | Ex- | Ex- | Ex- | Ex- | Ex- | Ex- | Ex- | Ex- | Ex- |
| | | | am- | am- | am- | am- | am- | am- | am- | am- | am- | am- |
| | | | ple | ple | ple | ple | ple | ple | ple | ple | ple | ple |
| | | | 1 | 2 | 3 | 4 | 5 | 6 | 7 | 8 | 9 | 10 |
| Component | [A1] | “TEPIC”-S | 5 | 45 | 35 | 25 | 15 | 15 | 25 | 15 | 15 | 25 |
| [A] | [A2] | “EPICLON”N-775 | 45 | 15 | 5 | 55 | 45 | 45 | 35 | 30 | 30 | 35 |
| | | “EPICLON”N-695 | | | | | | | | | | |
| | [A3] | “ARALDITE” | | | | | | | | 15 | | |
| | | MY0600 | | | | | | | | | | |
| | | “SUMI-EPOXY” | | | | | | | | | 15 | |
| | | ELM434 | | | | | | | | | | |
| | [A4] | “EPICLON”830 | 35 | 25 | 45 | 20 | 25 | 25 | 25 | 25 | 25 | 25 |
| | | “jER”4005P | 15 | 15 | 15 | | 15 | 15 | 15 | 15 | 15 | 15 |

| | | | | | | | | | | | |
|---|---|---|---|---|---|---|---|---|---|---|---|
| Component [B] | DICY7 | 4.6 | 6.2 | 5.9 | 5.9 | | 4.9 | 5.4 | 5.0 | 5.3 | 5.4 |
| Component [C] | 1,2-Propanediol | 5 | 5 | 5 | 5 | 5 | | 5 | 5 | 5 | 5 |
| | 2-Pyrrolidone | | | | | | | | | | |
| Component [D] | “Phenotohto” | 12 | 12 | 12 | 12 | 12 | 12 | | 12 | 12 | |
| | YP-70 | | | | | | | | | | |
| Component [E] | “Vinylec”K | | | | | | | 10 | | | |
| | “SUMIKAEXCEL” | | | | | | | | | | 10 |
| | PES 5003P | | | | | | | | | | |
| Component [F] | DCMU99 | 3 | 3 | 3 | 3 | 3 | 3 | 3 | 3 | 3 | 3 |
| Properties | Flexural strength | 170 | 167 | 173 | 171 | 178 | 169 | 190 | 194 | 190 | 190 |
| of resin | [MPa] | | | | | | | | | | |
| cured product | Flexural elastic | 4.1 | 5.0 | 4.7 | 4.7 | 4.0 | 4.1 | 4.7 | 4.6 | 4.5 | 4.7 |
| | modulus [GPa] | | | | | | | | | | |
| | Degree of | 11 | 18 | 15 | 18 | 9 | 15 | 30 | 31 | 32 | 12 |
| | yellowness | | | | | | | | | | |
| | Degree of | A | C | B | C | A | B | C | A | A | B |
| | transparency | | | | | | | | | | |
| | Weather | 7.8 | 6.1 | 6.7 | 7.5 | 7.4 | 7.8 | 12.1 | 15.5 | 16.1 | 17.1 |
| | resistance (ΔE) | | | | | | | | | | |
| Properties of | Tackiness of | 1.5 | 1.4 | 0.7 | 1.5 | 1.6 | 1.9 | 1.7 | 1.3 | 1.3 | 1.7 |
| prepreg | prepreg [kgf] | | | | | | | | | | |

1. A prepreg comprising reinforcing fibers and a resin composition, wherein said resin composition contains the following component [A] to component [D]:
component [A]: epoxy resins;
component [B]: dicyandiamide;
component [C]: a compound which has a boiling point of 130° C. or higher and a molecular weight m of 50 or more and 250 or less, which does not contain an epoxy group within the molecular structure, and which substantially does not have an epoxy resin curing ability; and
component [D]: a phenoxy resin; and
wherein said resin composition satisfies the following requirements (1) to (3):
(1): said resin composition contains from 10 to 40 parts by mass of an isocyanurate type epoxy resin [A1], as said component [A], with respect to 100 parts by mass of the total epoxy resin;
(2): said resin composition contains from 10 to 50 parts by mass of a novolac type epoxy resin [A2], as said component [A], with respect to 100 parts by mass of the total epoxy resin; and
(3): said resin composition contains 10 parts by mass or less of a glycidylamine type epoxy resin [A3], as said component [A], with respect to 100 parts by mass of the total epoxy resin.

2. The prepreg according to claim 1, wherein said resin composition does not substantially contain said glycidylamine type epoxy resin [A3].

3. The prepreg according to claim 1, wherein the content of said component [B] is from 4 to 9 parts by mass, with respect to 100 parts by mass of the total epoxy resin.

4. The prepreg according to claim 1, wherein said resin composition contains a bisphenol type epoxy resin [A4] as said component [A].

5. A fiber-reinforced composite material obtained by curing the prepreg according to claim 1.

6. A tubular fiber-reinforced composite material obtained by molding the prepreg according to claim 1 in the form of a tube.

7. A golf club shaft using the tubular fiber-reinforced composite material according to claim 6.

8. A fishing rod using the tubular fiber-reinforced composite material according to claim 6.
